(19) United States
(12) Patent Application Publication
(10) Pub. No.: US 2020/0124777 A1
(43) Pub. Date: Apr. 23, 2020

(54) COLOR FILM SUBSTRATE AND DISPLAY PANEL

(71) Applicant: HKC Corporation Limited, Shenzhen (CN)

(72) Inventor: Chuan Wu, Shenzhen (CN)

(21) Appl. No.: 16/245,240

(22) Filed: Jan. 10, 2019

Related U.S. Application Data
(63) Continuation of application No. PCT/CN2018/114678, filed on Nov. 9, 2018.

(30) Foreign Application Priority Data
Oct. 23, 2018 (CN) 201811238409.1

(51) Int. Cl. G02B 5/20; G02F 1/1362; G02F 1/1339

(52) U.S. Cl. CPC G02B 5/201; G02F 2001/136222; G02F 1/13392; G02F 1/136209

(57) ABSTRACT

Disclosed are a color film substrate and display panel, wherein a distance from a first spacer to a substrate is greater than a distance from a second spacer to the substrate; and the distance from the second spacer to the substrate is greater than a distance from a third spacer to the substrate.

### CROSS REFERENCE TO RELATED APPLICATIONS

The present application is a Continuation Application of PCT Application No. PCT/CN2018/114678 filed on Nov. 9, 2018, which claims the benefit of Chinese Patent Application No. 201811238409.1, filed with the Chinese Patent Office on Oct. 23, 2018 and entitled “color film substrate and display panel”, which is incorporated herein by reference in its entirety.

### FIELD OF THE DISCLOSURE

The present application relates to the technical field of liquid crystal displays, and in particular, to a color film substrate and a display panel applying the color film substrate.

### BACKGROUND OF THE DISCLOSURE

A thin film transistor liquid crystal display panel (TFT-LCD) comprises an array substrate and a color film substrate, wherein the array substrate, as a pixel switch, controls the deflection of the liquid crystal; and the color film substrate is configured to provide colors. Spacers are generally disposed between the array substrate and the color film substrate, and are used to support the gap therebetween, such that the array substrate and the color film substrate can, during a celling process and subsequent use, sustain a certain pressure, and maintain a certain liquid crystal cell thickness. A liquid crystal cell has a certain resilience, therefore, the liquid crystals filled therein have large range upper limit and lower limit, which requires a certain height difference between the spacers to improve product quality.

### SUMMARY OF THE DISCLOSURE

The main object of the present application is to provide a color film substrate, with the purpose of simplifying manufacturing process and reducing manufacturing cost while the spacers in the color film substrate satisfy a level difference requirement.

To achieve the above object, the color film substrate provided by the present application comprises:

A substrate;

A black matrix, coated on the substrate, and defining on the substrate a plurality of first transparent areas, a plurality of second transparent areas and a plurality of third transparent areas;

A color resistor layer, comprising a first color barrier, a second color barrier and a third color barrier, wherein the first color barrier, the second color barrier and the third color barrier are respectively coated on the first transparent areas, the second transparent areas and the third transparent areas; the first color barrier and the second color barrier are further coated on a part of the black matrix; and

A spacer layer, comprising a first spacer, a second spacer and a third spacer, wherein the first spacer is coated on the first color barrier on the black matrix; the second spacer is coated on the second color barrier on the black matrix; and the third spacer is coated on the black matrix;

A distance from the substrate to a surface of the first spacer away from the substrate is greater than a distance from the substrate to a surface of the second spacer away from the substrate; and the distance from the substrate to the surface of the second spacer away from the substrate is greater than a distance from the substrate to a surface of the third spacer away from the substrate.

Alternatively, the thicknesses of the first spacer and the second spacer are consistent.

Alternatively, the thicknesses of the first spacer, the second spacer and the third spacer are consistent.

Alternatively, the thickness of the first color barrier is greater than the thickness of the second color barrier.

Alternatively, the area that the first spacer is attached to the first color barrier, the area that the second spacer is attached to the second color barrier, and the area that the third spacer is attached to the black matrix are consistent.

Alternatively, the first color barrier, the second color barrier and the third color barrier are sequentially disposed side by side.

Alternatively, the first color barrier is a blue color barrier; the second color barrier is a green color barrier; and the third color barrier is a red color barrier.

Alternatively, the first color barrier, the third color barrier and the second color barrier are sequentially disposed side by side.

Alternatively, the first color barrier is a blue color barrier; the third color barrier is a green color barrier; and the second color barrier is a red color barrier.

Alternatively, a first attachment area, a second attachment area and a third attachment area are all in a strip shape.

Alternatively, the thickness of the first spacer is greater than the thickness of the second spacer; and the thickness of the second spacer is greater than the thickness of the third spacer.

Alternatively, the longitudinal section of the first spacer is in a trapezoid shape.

The present application further provides a color film substrate, comprising:

A substrate;

A black matrix, coated on the substrate, and defining on the substrate a plurality of first transparent areas, a plurality of second transparent areas and a plurality of third transparent areas;

A color resistor layer, comprising a first color barrier, a second color barrier and a third color barrier which are sequentially disposed side by side, wherein the first color barrier, the second color barrier and the third color barrier are respectively coated on the first transparent areas, the second transparent areas and the third transparent areas; the first color barrier and the second color barrier are further coated on a part of the black matrix; and

A spacer layer, comprising a first spacer, a second spacer and a third spacer, wherein the first spacer is coated on the first color barrier on the black matrix; the second spacer is coated on the second color barrier on the black matrix; and the third spacer is coated on the black matrix;

The thickness of the first color barrier is greater than the thickness of the second color barrier; the thicknesses of the first spacer, the second spacer and the third spacer are consistent.

The present application further provides a display panel, comprising an array substrate and a color film substrate, wherein the array substrate presses against one side of the spacer layer away from the substrate.

The color film substrate comprises:

A substrate;

A black matrix, coated on the substrate, and defining on the substrate a plurality of first transparent areas, a plurality of second transparent areas and a plurality of third transparent areas;

A color resistor layer, comprising a first color barrier, a second color barrier and a third color barrier, wherein the first color barrier, the second color barrier and the third color barrier are respectively coated on the first transparent areas, the second transparent areas and the third transparent areas; the first color barrier and the second color barrier are further coated on the black matrix between two adjacent transparent areas; and

A spacer layer, comprising a first spacer, a second spacer and a third spacer, wherein the first spacer is coated on the first color barrier on the black matrix; the second spacer is coated on the second color barrier on the black matrix; and the third spacer is coated on the black matrix;

A distance from the substrate to a surface of the first spacer away from the substrate is greater than a distance from the substrate to a surface of the second spacer away from the substrate; and the distance from the substrate to the surface of the second spacer away from the substrate is greater than a distance from the substrate to a surface of the third spacer away from the substrate.

In the technical solution of the present application, the color film substrate can utilize the thicknesses of the first color barrier and the second color barrier to ensure the free ends of the first spacer and the second spacer to be higher than at least the free end of the third spacer. The first color barrier located on the black matrix and the first color barrier in the first transparent areas can be manufactured in the same process; the second color barrier located on the black matrix and the second color barrier in the second transparent areas can be manufactured in the same process; therefore, the first spacer, the second spacer and the third spacer form height level differences without changing the original color film substrate manufacturing process, thus simplifying manufacturing process and reducing manufacturing cost.

### BRIEF DESCRIPTION OF THE DRAWINGS

In order to more clearly illustrate the technical solutions in the embodiments of the present application or in the prior art, a brief introduction will be made hereafter to the drawings required for the description of the embodiments or the prior art. It would be obvious that the drawings described below are only some embodiments of the present application, and a person skilled in the art could obtain other drawings according to the structures shown in the drawings without involving an inventive effort.

FIG. 1 is a vertical view of the color film substrate according to one embodiment of the present application;

FIG. 2 is a structural schematic view of a part of the color film substrate after the color film substrate in FIG. 1 is cut away in the A-A direction;

FIG. 3 is a structural sectional view of a part of the display panel according to one embodiment of the present application;

FIG. 4 is a structural sectional view of a part of the color film substrate according to another embodiment of the present application; and

FIG. 5 is a structural sectional view of a part of the display panel according to another embodiment of the present application.

### DESCRIPTION OF THE LABELS IN THE DRAWINGS

| Label | Name | Label | Name |
|---|---|---|---|
| 100 | color film substrate | 32 | Second color barrier |
| 10 | Substrate | 33 | Third color barrier |
| 11 | First attachment area | 40 | Spacer layer |
| 12 | Second attachment area | 41 | First spacer |
| 13 | Third attachment area | 42 | Second spacer |
| 20 | Black matrix | 43 | Third spacer |
| 30 | Color barrier layer | 200 | Array substrate |
| 31 | First color barrier | | |

With reference to the drawings, the implement of the object, features and advantages of the present application will be further illustrated in conjunction with embodiments.

### DETAILED DESCRIPTION OF THE EMBODIMENTS

The technical solutions in the embodiments of the present application will be clearly and completely described hereafter in connection with the drawings in embodiments of the present application. It is apparent that the described embodiments are only a part of the embodiments of the present application, but not the whole. Based on the embodiments of the present application, all the other embodiments obtained by those of ordinary skill in the art without inventive effort are within the scope of the present application.

It should be noted that all the directional indications (such as up, down, left, right, front, back, . . . ) in the embodiments of the present application are only configured to explain the relative position relationship, the motion condition and the like between the components under a specific attitude (as shown in the drawings), and if the specific attitude changes, then the directional indications also change accordingly.

In addition, the descriptions of “first”, “second” and the like in the present application are configured for the purpose of description only, and are not to be construed as indicating or implying the relative importance thereof or implicitly indicating the number of indicated technical features. Thus, a feature defined by “first” or “second” may explicitly or implicitly comprises at least one of the features. In addition, the technical solutions of various embodiments may be combined with each other only on the basis that a person skilled in the art can realize the combination; when the combination of the technical solutions contradicts each other or is impossible to realize, the combination of the technical solutions should be considered to be non-existent, nor is not in the protection scope claimed by the present application.

The present application provides a color film substrate 100. Spacers are formed on the color film substrate 100; the color film substrate 100 and an array substrate 200 are oppositely disposed in a display panel of a display; the array substrate 200 is located on one side of the color film substrate 100 provided with the spacers, and presses against the spacers; and the spacers are utilized to support the color film substrate 100 and the array substrate 200. Disposing the spacers at different heights can uniformize a liquid crystal layer flowing between the color film substrate 100 and the array substrate 200, can ensure the filling amount of the liquid crystals, and avoid the adverse effect on the product caused by a liquid crystal dripping amount error.

The level difference between the spacers is dependent on the thicknesses of the spacers themselves and the height from the upper surface of the color barrier 30 to the substrate 10. In the spacer manufacturing process, the positions and thicknesses of the spacers are controlled by utilizing a gray tone mask plate or a half tone mask plate in connection with different exposure degrees. If the level difference between the spacers is improved by changing the thicknesses of the spacers, then different gray tone mask plates or half tone mask plates are required. However, the gray tone mask plates or half tone mask plates have relatively high prices, thus improving the manufacturing cost of the color film substrate 100.

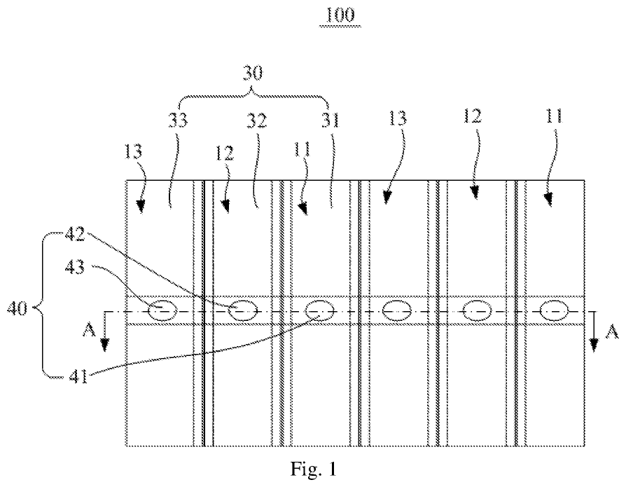

With reference to FIG. 1-5, in the embodiment of the present application, the color film substrate 100 comprises:

A substrate 10;

a black matrix 20, coated on the substrate 10, and defining on the substrate 10 a plurality of first transparent areas, a plurality of second transparent areas and a plurality of third transparent areas;

a color resistor layer 30, comprising a first color barrier 31, a second color barrier 32 and a third color barrier 33, wherein the first color barrier 31, the second color barrier 32 and the third color barrier 33 are respectively coated on the first transparent areas, the second transparent areas and the third transparent areas; the first color barrier 31 and the second color barrier 32 are further coated on a part of the black matrix 20; and

a spacer layer 40, comprising a first spacer 41, a second spacer 42 and a third spacer 43, wherein the first spacer 41 is coated on the first color barrier 31 on the black matrix 20; the second spacer 42 is coated on the second color barrier 32 on the black matrix 20; and the third spacer 43 is coated on the black matrix 20;

A distance from the substrate 10 to a surface of the first spacer 41 away from the substrate 10 is greater than a distance from the substrate 10 to a surface of the second spacer 42 away from the substrate 10; and the distance from the substrate 10 to the surface of the second spacer 42 away from the substrate 10 is greater than a distance from the substrate 10 to a surface of the third spacer 43 away from the substrate 10.

In the technical solution of the present application, the black matrix 20 is coated on the substrate 10, so as to define on the transparent substrate 10 a plurality of alternately disposed transparent areas and opaque areas, wherein the opaque areas are the areas provided with the black matrix 20 and impenetrable by the light on the other side of the substrate 10. The plurality of transparent areas and the plurality of opaque areas are divided to form a plurality of pixel areas. The transparent areas are coated with the color barriers with different colors, such that under the irradiation of the light and the control of the voltage, each pixel area can present different colors. The plurality of transparent areas are respectively a plurality of first transparent areas, a plurality of second transparent areas and a plurality of third transparent areas. The plurality of the first transparent areas are sequentially arranged in parallel to form a plurality of strips; the plurality of the second transparent areas are sequentially arranged in parallel to form a plurality of strips; and the plurality of the third transparent areas are sequentially arranged in parallel to form a plurality of strips. The first color barrier 31, the second color barrier 32 and the third color barrier 33 are respectively coated on the first transparent areas, the second transparent areas and the third transparent areas; the first color barrier 31 and the second color barrier 32 are further coated on the black matrix 20 between two adjacent transparent areas, such that the overall height of the black matrix 20 coated with the first color barrier 31 and the second color barrier 32 is improved. And then, the first spacer 41 is coated on the first color barrier 31 on the black matrix 20; the second spacer 42 is coated on the second color barrier 32 on the black matrix 20; and the third spacer 43 is directly coated on the black matrix 20. The thicknesses of the first color barrier 31 and the second color barrier 32 themselves ensure the free ends of the first spacer 41 and the second spacer 42 to be higher than at least the free end of the third spacer 43. The first color barrier 31 located on the black matrix 20 and the first color barrier 31 in the first transparent areas can be manufactured in the same process; the second color barrier 32 located on the black matrix 20 and the second color barrier 32 in the second transparent areas can be manufactured in the same process; therefore, the first spacer 41, the second spacer 42 and the third spacer 43 form height level differences without changing the original color film substrate 100 manufacturing process, thus simplifying manufacturing process and reducing manufacturing cost.

With reference to FIG. 1, a first attachment area 11, a second attachment area 12 and a third attachment area 13 are formed on the substrate 10 of the color film substrate 100; the first attachment area 11, the second attachment area 12 and the third attachment area 13 are disposed in a strip shape; the black matrix 20 defines on the substrate 10 a plurality of transparent areas and opaque areas; the first attachment area 11, the second attachment area 12 and the third attachment area 13 all comprise a plurality of transparent areas disposed in a strip shape, and an opaque area located between two adjacent transparent areas; the opaque area is the black matrix 20 between two adjacent transparent areas. Generally, the first attachment area 11, the second attachment area 12 and the third attachment area 13 are respectively coated with the first color barrier 31, the second color barrier 32 and the third color barrier 33. Namely, the first color barrier 31 is coated on the plurality of first transparent areas and the black matrix 20 between two adjacent first transparent areas in the first attachment area 11; the second color barrier 32 is coated on the plurality of second transparent areas and the black matrix 20 between two adjacent second transparent areas in the second attachment area 12; and the third color barrier 33 is coated on the plurality of third transparent areas and the black matrix 20 between two adjacent third transparent areas in the third attachment area 13. Alternatively, the first color barrier 31 is only coated on the plurality of transparent areas in the first attachment area 11; the second color barrier 32 is only coated on the plurality of transparent areas in the second attachment area 12; and the third color barrier 33 is only coated on the plurality of transparent areas in the third attachment area 13.

Further, the plurality of transparent areas are respectively a plurality of first transparent areas arranged in parallel in a strip shape, a plurality of second transparent areas arranged in parallel in a strip shape and a plurality of third transparent areas arranged in parallel in a strip shape. In the technical solution of the present application, the first color barrier 31 is coated on the plurality of first transparent areas and the black matrix 20 between two adjacent first transparent areas in the first attachment area 11; the second color barrier 32 is coated on the plurality of second transparent areas and the black matrix 20 between two adjacent second transparent areas in the second attachment area 12. The first spacer 41 is coated on the first color barrier 31 on the black matrix 20; and the second spacer 42 is coated on the second color barrier 32 on the black matrix 20. In the manufacturing process of the third color barrier 33, the third color barriers 33 located in the third transparent areas 33 are directly removed by using a developing solution, therefore, only the black matrix 20 is remained between two adjacent third transparent areas; and the third spacer 43 is directly coated on the black matrix 20 to satisfy the level difference requirement.

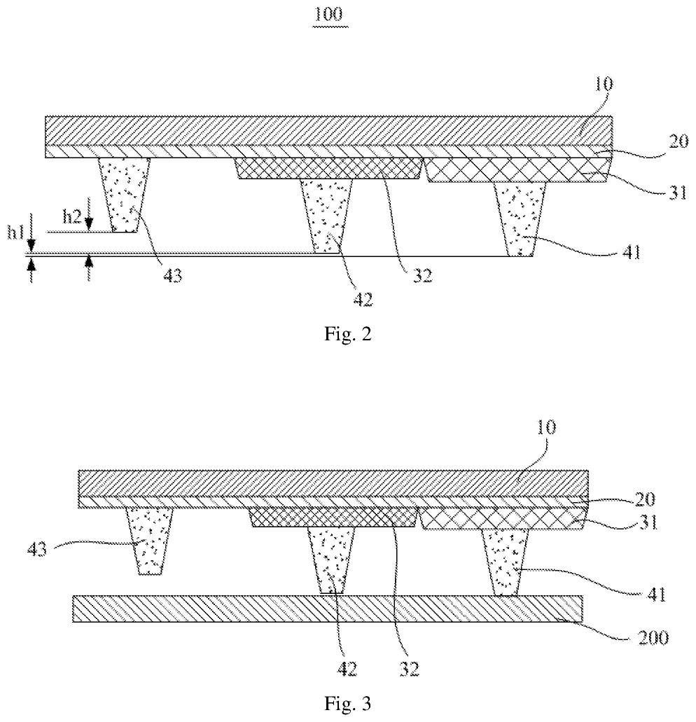

With reference to FIG. 2-3, the thickness of the first color barrier is greater than the thickness of the second color barrier. In the embodiment, the surfaces of the formed first spacer 41, second spacer 42 and third spacer 43 have certain height differences, such that even the first spacer 41, the second spacer 42 and the third spacer 43 have the same thickness, the free ends of the first spacer 41, the second spacer 42 and the third spacer 43 can also form three level differences. Therefore, after the color film substrate 100 and the array substrate 200 are celled, the array substrate 200, once subject to an external pressure, can be supported at different heights, thus improving the good product rate of the display panel.

Further, the thicknesses of the first spacer 41 and the second spacer 42 are consistent. In the embodiment, the thicknesses of the first spacer 41 and the second spacer 42 are configured to be equal, such that when the spacer layer is formed, the manufacturing of the mask plate can be simplified, and the shapes and sizes of the spacers can be easily controlled. It can be understood that the thicknesses of the first spacer 41 and the second spacer 42 can also be inconsistent. In another embodiment, the thickness of the first spacer 41 is greater than the thickness of the second spacer 42, so as to further improve the level difference between the free ends of the first spacer 41 and the second spacer 42. In the embodiment, the thickness difference between the first spacer 41 and the second spacer 42 can be small, such that the pore diameter of the mask plate can be directly adjusted without being replaced with another mask plate at a high cost.

In order to further reduce the manufacturing cost and more easily control the shape and size of each spacer, the thicknesses of the first spacer 41, the second spacer 42 and the third spacer 43 can be configured to be consistent.

It can be understood that the thicknesses of the first spacer 41, the second spacer 42 and the third spacer 43 can also be configured to be inconsistent. The thickness of the first spacer 41 is greater than the thickness of the second spacer 42, and the thickness of the second spacer 42 is greater than the thickness of the third spacer 43, so as to further improve the level difference range between the three. The thickness differences between the first spacer 41, the second spacer 42 and the third spacer 43 can be controlled by changing the pore diameter of the mask plate, thus having little influence on the overall cost of the color film substrate 100.

In one embodiment of the present application, the area that the first spacer 41 is attached to the first color barrier 31, the area that the second spacer 42 is attached to the second color barrier 32, and the area that the third spacer 43 is attached to the black matrix 20 are consistent. In the embodiment, the force application areas of the first spacer 41, the second spacer 42 and the third spacer 43 are consistent; and every two spacers in one pixel area form a level difference therebetween, such that in the pressure sustaining process of the display panel, each spacer can share the pressure in a certain gap range. Therefore, the structure simplifies the manufacturing process while the spacer layer ensures the good product rate of the display panel.

Still further, the shapes and sizes of the first spacer 41, the second spacer 42 and the third spacer 43 are consistent. In the embodiment, the pore diameters of formed holes on the mask plates of the formed first spacer 41, second spacer 42 and third spacer 43 are configured to be consistent, thus still further simplifying the manufacturing processes of the first spacer 41, the second spacer 42 and the third spacer 43.

With reference to FIG. 2-3, the first color barrier 31, the second color barrier 32 and the third color barrier 33 are sequentially disposed side by side. In the embodiment, the heights of the free ends of the first spacer 41, the second spacer 42 and the third spacer 43 sequentially descend; the first spacer 41 and the second spacer 42 form a height level difference h1 therebetween; the second spacer 42 and the third spacer 43 form a height level difference h2 therebetween; therefore, the surface of the color film substrate 100 facing the array substrate 200 presents a stepwise arranged abutment end, thus better equalizing the sustained external pressure.

In connection with FIG. 1-2, the first color barrier 31 is a blue color barrier; the second color barrier 32 is a green color barrier; and the third color barrier 33 is a red color barrier. In the embodiment, the first spacer 41, the second spacer 42 and the third spacer 43 are respectively disposed on the blue color barrier, the green color barrier and the red color barrier, and are sequentially arranged in parallel. The thickness of the blue color barrier is greater than the thickness of the green color barrier; and the thicknesses of the first spacer 41, the second spacer 42 and the third spacer 43 are consistent. The technical solution utilizes the thicknesses of the blue color barrier and the green color barrier themselves to realize the level difference between the first spacer 41 and the second spacer 42, utilizes the thickness of the green color barrier itself to realize the level difference between the second spacer 42 and the third spacer 43, such that the first spacer 41, the second spacer 42 and the third spacer 43 sequentially form steplike level differences therebetween. The embodiment can utilize the conventional manufacturing process of the color film substrate 100 to direct form multiple level differences, and can ensure the pressure sustaining capability of the display panel of the color film substrate 100 to be good.

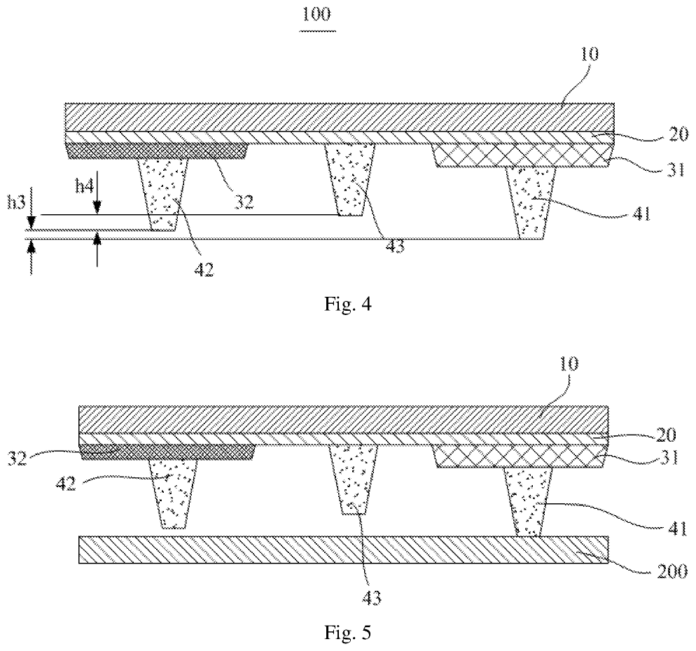

With reference to FIG. 4-5, the first color barrier 31, the third color barrier 33 and the second color barrier 32 are sequentially disposed side by side. In the embodiment, the level difference between the first spacer 41 and the adjacent third spacer 43 is greater than the level difference between the first spacer 41 and the separated second spacer 42; the first spacer 41 and the second spacer 42 form a height level difference h3 therebetween; the second spacer 42 and the third spacer 43 form a height level difference h4 therebetween. With the structure, in the pressure sustaining process of the display panel, after the first spacer 41 is pressed and generates an elastic deformation, the array substrate 200 first contacts the second spacer 42 separately disposed from the first spacer 41, and then contacts the third spacer 43 located between the first spacer 41 and the second spacer 42, such that the pressure can be averaged step by step by the pixel areas, thus enabling the overall pressure balancing capability of the display panel to be better.

Further, the first color barrier 31 is a blue color barrier; the third color barrier 33 is a green color barrier; and the second color barrier 32 is a red color barrier. In the embodiment, the first spacer 41 is disposed on the blue color barrier; the second spacer 42 is disposed on the red color barrier; and the third spacer 43 is disposed on the black matrix 20. Generally, the thickness of the blue color barrier is greater than the thickness of the green color barrier; and the thickness of the green color barrier is greater than the thickness of the red color barrier. Therefore, the embodiment differs from the above-described embodiments in that: the level difference between adjacent spacers is different; and the level difference between the first spacer 41 and the second spacer 42 is also inconsistent. Since the thickness of the green color barrier is greater than the thickness of the red color barrier, the embodiment further improves the level difference between the first spacer 41 and the second spacer 42, reduces the level difference between the second spacer 42 and the third spacer 43, and remains the level difference between the first spacer 41 and the third spacer 43 unchanged.

The present application further provides a display panel, comprising an array substrate 200 and a color film substrate 100, wherein the structure of the color film substrate 100 can refer to the embodiments above. The display panel adopts the entire technical solutions of all the above embodiments. Therefore, the display panel at least all the beneficial effects brought by the technical solutions of the above embodiments, and the details will not be repeated here, wherein the array substrate 200 presses against one side of the spacer layer 40 away from the color film substrate 100.

The manufacturing method of the color film substrate 100 in the present application comprises the following steps:

First manufacturing a black matrix 20 on the substrate 10;

The black matrix 20 defines on the substrate 10 a plurality of first transparent areas, a plurality of second transparent areas and a plurality of third transparent areas. The manufacturing method of the black matrix 20 is the same as that in the prior art, and will not be repeated here.

Then, coating the first color barrier 31, the second color barrier 32 and the third color barrier 33 on the black matrix 20, and using a photoresist raw material to photoetch the substrate 10 to respectively form red, green and blue strip-shaped color units. In one embodiment, in the formation process of the third color barrier 30 layer 30, the area in which the spacer 43 will be disposed is covered with a mask plate to prevent exposure; and then in the subsequent manufacturing process, the third color barrier 33 in the area is removed by using a developing solution, so as to expose the black matrix 20 below.

Then, a pixel electrode layer (unshown in the figure) is disposed on the color barrier 30 in a conventional manner; next, the spacer layer 40 is formed on the pixel electrode layer. The first spacer 41, the second spacer 42 and the third spacer 43 in the spacer layer 40 are formed in the same manufacturing process, and have the same formation shape.

In the embodiment of the present application, the longitudinal section of the first spacer 41 is in a trapezoid shape, such that the first spacer 41 can be compressed under the acting force of the array substrate 200, and can remain a certain fitting allowance. It can be understood that the first spacer 41 can also be configured in other shapes in the prior art which can also satisfy use requirements. The shapes of the second spacer 42 and the third spacer 43 are consistent with the shape of the first spacer 41.

It can be understood that the first color barrier 31, the second color barrier 32 and the third color barrier 33 are not limited to the above-described arrangement mode, and can also adopt the arrangement mode of blue layer, green layer and red layer, and the color barrier layer 30 is not limited to the colors of blue, green and red, and can also adopt other colors. The arrangement modes and the color barrier layers in various colors are all concluded in the protection scope of the present application.

The descriptions above are only the alternative embodiments of the present application, but not intended to limit the patent scope of the present application. Any equivalent structural variations made by utilizing the specification and drawings of the present application under the inventive concept of the present application, or direct or indirect applications in other related technical fields should be concluded in the patent protection scope of the present application.

What is claimed is:

1. A color film substrate, comprising:
a substrate;
a black matrix, coated on the substrate, and defining on the substrate a plurality of first transparent areas, a plurality of second transparent areas and a plurality of third transparent areas;
a color resistor layer, comprising a first color barrier, a second color barrier and a third color barrier, wherein the first color barrier, the second color barrier and the third color barrier are respectively coated on the first transparent areas, the second transparent areas and the third transparent areas; the first color barrier and the second color barrier are further coated on a part of the black matrix; and
a spacer layer, comprising a first spacer, a second spacer and a third spacer, wherein the first spacer is coated on the first color barrier on the black matrix; the second spacer is coated on the second color barrier on the black matrix; and the third spacer is coated on the black matrix;
a distance from the substrate to a surface of the first spacer away from the substrate is greater than a distance from the substrate to a surface of the second spacer away from the substrate; and the distance from the substrate to the surface of the second spacer away from the substrate is greater than a distance from the substrate to a surface of the third spacer away from the substrate.

2. The color film substrate according to claim 1, wherein the thicknesses of the first spacer and the second spacer are consistent.

3. The color film substrate according to claim 1, wherein the thicknesses of the first spacer, the second spacer and the third spacer are consistent.

4. The color film substrate according to claim 1, wherein the thickness of the first color barrier is greater than the thickness of the second color barrier.

5. The color film substrate according to claim 1, wherein the area that the first spacer is attached to the first color barrier, the area that the second spacer is attached to the second color barrier, and the area that the third spacer is attached to the black matrix are consistent.

6. The color film substrate according to claim 1, wherein the first color barrier, the second color barrier and the third color barrier are sequentially disposed side by side.

7. The color film substrate according to claim 6, wherein the first color barrier is a blue color barrier; the second color barrier is a green color barrier; and the third color barrier is a red color barrier.

8. The color film substrate according to claim 1, wherein the first color barrier, the third color barrier and the second color barrier are sequentially disposed side by side.

9. The color film substrate according to claim 8, wherein the first color barrier is a blue color barrier; the third color barrier is a green color barrier; and the second color barrier is a red color barrier.

10. The color film substrate according to claim 1, wherein a first attachment area, a second attachment area and a third attachment area are all in a strip shape.

11. The color film substrate according to claim 1, wherein the thicknesses of the first spacer is greater than the thickness of the second spacer; and the thickness of the second spacer is greater than the thickness of the third spacer.

12. The color film substrate according to claim 1, wherein the longitudinal section of the first spacer is in a trapezoid shape.

13. A color film substrate, comprising:
a substrate;
a black matrix, coated on the substrate, and defining on the substrate a plurality of first transparent areas, a plurality of second transparent areas and a plurality of third transparent areas;
a color resistor layer, comprising a first color barrier, a second color barrier and a third color barrier which are sequentially disposed side by side, wherein the first color barrier, the second color barrier and the third color barrier are respectively coated on the first transparent areas, the second transparent areas and the third transparent areas; the first color barrier and the second color barrier are further coated on a part of the black matrix; and
a spacer layer, comprising a first spacer, a second spacer and a third spacer, wherein the first spacer is coated on the first color barrier on the black matrix; the second spacer is coated on the second color barrier on the black matrix; and the third spacer is coated on the black matrix;
the thickness of the first color barrier is greater than the thickness of the second color barrier; the thicknesses of the first spacer, the second spacer and the third spacer are consistent.

14. A display panel, comprising an array substrate and a color film substrate;
the color film substrate comprises:
a substrate;
a black matrix, coated on the substrate, and defining on the substrate a plurality of first transparent areas, a plurality of second transparent areas and a plurality of third transparent areas;
a color resistor layer, comprising a first color barrier, a second color barrier and a third color barrier, wherein the first color barrier, the second color barrier and the third color barrier are respectively coated on the first transparent areas, the second transparent areas and the third transparent areas; the first color barrier and the second color barrier are further coated on a part of the black matrix; and
a spacer layer, comprising a first spacer, a second spacer and a third spacer, wherein the first spacer is coated on the first color barrier on the black matrix; the second spacer is coated on the second color barrier on the black matrix; and the third spacer is coated on the black matrix;
a distance from the substrate to a surface of the first spacer away from the substrate is greater than a distance from the substrate to a surface of the second spacer away from the substrate; and the distance from the substrate to the surface of the second spacer away from the substrate is greater than a distance from the substrate to a surface of the third spacer away from the substrate;
the array substrate presses against one side of the spacer layer away from the substrate.

15. The display panel according to claim 14, wherein the thicknesses of the first spacer and the second spacer are consistent.

16. The display panel according to claim 14, wherein the thicknesses of the first spacer, the second spacer and the third spacer are consistent.

17. The display panel according to claim 14, wherein the thickness of the first color barrier is greater than the thickness of the second color barrier.

18. The color film substrate according to claim 14, wherein the thicknesses of the first spacer is greater than the thickness of the second spacer; and the thickness of the second spacer is greater than the thickness of the third spacer.
